(19) United States
(12) Patent Application Publication
(10) Pub. No.: US 2025/0080887 A1
(43) Pub. Date: Mar. 6, 2025

(54) FENDER-MOUNTED SPEAKER SYSTEM

(71) Applicant: Bombardier Recreational Products, Inc., Valcourt (CA)

(72) Inventors: Felix Savoie, Sherbrooke (CA); Remi Larrouy, Sherbrooke (CA)

(21) Appl. No.: 18/822,049

(22) Filed: Aug. 30, 2024

Related U.S. Application Data
(60) Provisional application No. 63/579,823, filed on Aug. 31, 2023.

(51) Int. Cl. H04R 1/02

(52) U.S. Cl. CPC H04R 1/025

(57) ABSTRACT

A fender mounted speaker system for a vehicle may comprise a plurality of speakers operatively connected to the vehicle for sound generation. Each of the speakers may be mounted to the fender of the vehicle so as to be equally spaced from the vehicle's longitudinal axis, forward of the transverse axis of the vehicle, and/or forward of the steering axis of the vehicle.

### RELATED APPLICATIONS

This application is a non-provisional application claiming the benefit of U.S. Provisional Patent Application Ser. No. 63/579,823, filed on Aug. 31, 2023, the entire disclosures of which being incorporated herein by reference in their entirety.

### FIELD OF THE INVENTION

The present invention relates to entertainment mounting for all-terrain vehicles, in particular, speaker systems to be used with sound devices.

### BACKGROUND

In typical all-terrain vehicle (“ATV”) accessory configurations, an audio device is attached to the front rack of the vehicle and/or the steering assembly. As such, audio devices may take up space or locations on the ATV better suited for other accessories, e.g., tools, equipment.

In other scenarios, after-market companies have provided sound producing mechanisms located proximal to the sound device mounting location on the ATV. In these scenarios, the user may be unable to hear the sound as they travel due to the proximity of the sound emission to those features that may be partly obscured by moving parts (e.g., the steering mechanisms), or are otherwise prone to being interrupted by the movement of those parts in their proximity.

### SUMMARY

The vehicle may have a longitudinal axis, a transverse axis, and a steering axis such that the longitudinal axis is an axis along a major length of the vehicle, wherein the transverse axis is perpendicular to the longitudinal axis and intersects a steering column of the vehicle, wherein the steering axis is perpendicular to the longitudinal axis and the transverse axis and intersects a point of rotation of the steering column of the vehicle.

An exemplary fender mounted speaker system for such a vehicle may comprise a plurality of speakers operatively connected to the vehicle for sound generation. In an exemplary fender mounted speaker system, each one of the plurality of speakers may have a plurality of mounting points disposed on one surface of its casing and a sound emission point disposed on another surface of the casing and a fender mount on either side of the longitudinal axis of the vehicle. An exemplary fender mounted speaker system may further comprise a plurality of mountings configured to align with at least one of the plurality of mounting points of each of the plurality of speakers. An exemplary fender mounted speaker system may be further configured such that at least two of the plurality of speakers is mounted to a part of the vehicle so that the sound emission point of the at least two of the plurality of speakers is either bisected by and equidistant from the longitudinal axis, forward of the transverse axis, forward of the steering axis, or combinations of the same.

In addition to the previously described embodiment and/or as an alternative to any other described exemplary embodiment, an exemplary fender mounted speaker system may further comprise a plurality of speakers mounted to the all-terrain vehicle by two different fenders.

In addition to the previously described embodiment and/or as an alternative to any other described exemplary embodiment, an exemplary fender mounted speaker system may be configured such that at least two of the plurality of speakers is mounted to a part of the vehicle so that the sound emission point of the at least two of the plurality of speakers is forward of the steering column and arranged to avoid full rotation of the steering mechanism.

In addition to the previously described embodiment and/or as an alternative to any other described exemplary embodiment, an exemplary fender mounted speaker system may be configured such that the sound emission point of the at least two of the plurality of speakers is bisected by and equidistant from the longitudinal axis and forward of the transverse axis.

In addition to the previously described embodiment and/or as an alternative to any other described exemplary embodiment, an exemplary fender mounted speaker system may be configured such that the sound emission point of the at least two of the plurality of speakers is bisected by and equidistant from the longitudinal axis and forward of the steering axis.

In addition to the previously described embodiment and/or as an alternative to any other described exemplary embodiment, an exemplary fender mounted speaker system may be configured such that the sound emission point of the at least two of the plurality of speakers is forward of the transverse axis and forward of the steering axis.

In addition to the previously described embodiment and/or as an alternative to any other described exemplary embodiment, an exemplary fender mounted speaker system may be configured such that the sound emission point of the at least two of the plurality of speakers is only forward of the transverse axis.

In addition to the previously described embodiment and/or as an alternative to any other described exemplary embodiment, an exemplary fender mounted speaker system may be configured such that the sound emission point of the at least two of the plurality of speakers is only forward of the steering axis.

In addition to the previously described embodiment and/or as an alternative to any other described exemplary embodiment, an exemplary fender mounted speaker system may be configured such that each of the plurality of speakers is arranged to avoid sound interference from a steering mechanism for the vehicle, wherein the steering mechanism comprises the steering column.

In addition to the previously described embodiment and/or as an alternative to any other described exemplary embodiment, an exemplary fender mounted speaker system may be configured such that the fender belongs to an all-terrain vehicle having at least one wheel disposed below the fender.

In addition to the previously described embodiment and/or as an alternative to any other described exemplary embodiment, an exemplary fender mounted speaker system may be configured such that the fender mounted speaker system is electrically coupled to the all-terrain vehicle using pre-existing electrical connections for a console on the all-terrain vehicle.

In addition to the previously described embodiment and/or as an alternative to any other described exemplary embodiment, an exemplary fender mounted speaker system may be configured such that at least a portion of the electrical coupling for the fender mounted speaker system is disposed under the fender.

In addition to the previously described embodiment and/or as an alternative to any other described exemplary embodiment, an exemplary fender mounted speaker system may be configured such that the electrical coupling for the fender mounted speaker system is entirely disposed under the fender.

In addition to the previously described embodiment and/or as an alternative to any other described exemplary embodiment, an exemplary fender mounted speaker system may be configured such that each speaker of the speaker system is angled on the fender so as to avoid full rotation of the steering mechanism.

In addition to the previously described embodiment and/or as an alternative to any other described exemplary embodiment, an exemplary fender mounted speaker system may be configured such that

### DESCRIPTION OF THE DRAWINGS

FIG. 1 illustrates a sectioned isometric topographic view of an exemplary fender mounted speaker system as may be used on an ATV.

FIG. 2 illustrates an exemplary bottom view of the exemplary fender mounted speaker system illustrated in FIG. 1.

FIG. 3 illustrates an exemplary plan view of the exemplary fender mounted speaker system illustrated in FIG. 1.

FIG. 4 illustrates an exemplary top view of the exemplary fender mounted speaker system illustrated in FIG. 1.

In the drawings like characters of reference indicate corresponding parts in the different and interchangeable and interrelated figures. Parts and components of each figure may be substitutes for other components in other figures to achieve the various methods and embodiments disclosed herein. Methods and protocols disclosed in any embodiment may be run in any order so as to affect their disclosed goals and/or enable performance of the systems as described. Additionally, any one embodiment may utilize any method or protocol described and in any portions, sequences, and combinations thereof.

### DETAILED DESCRIPTION

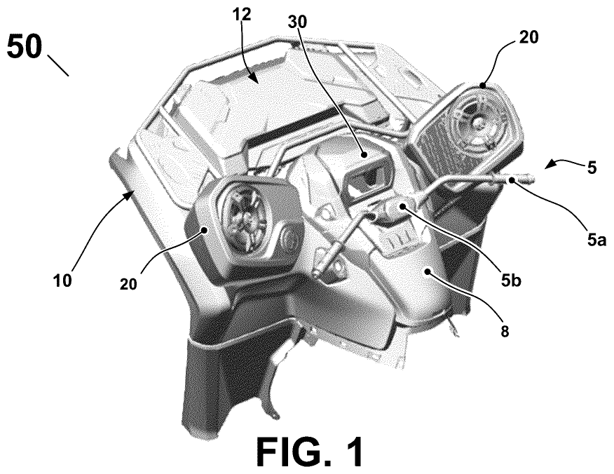

Referring to FIG. 1, an embodiment of an exemplary fender-mounted speaker system 50 may be illustrated with respect to its use on an ATV, although the disclosures herein may be applicable to any known type of recreational devices, e.g., snowmobiles, side-by-sides, personal watercraft, buggies.

An exemplary speaker system 50 may be shown coupled to the fender 10 of an exemplary ATV. The system 50 may comprise a plurality of speakers 20 of the conventional variety and known to those skilled in the art. Alternatively, speakers 20 may be slightly modified to have amplifiers that accommodate the line out and auxiliary wiring of a particular vehicle and/or vehicle console 30.

With continued reference to FIG. 1, the speakers 20 may be separated from one another at their respective mounted positions on fender 10 by the vehicle steering mechanism 5, the center cowling 8, the front cowling 12, and the front console 30. As illustrated, exemplary speakers 20 may be designed so that their bottom surfaces are flush and configured to substantially seamlessly engage with the fender 10 of the particular vehicle. In an exemplary embodiment, the speakers 20 may be attached to the fender 10 at points where it has been determined to be the minimal amount of vibration and/or acoustic interference due to vehicle usage. In a preferred embodiment, the mounting point on fender 10 for an exemplary speaker 20 may be that which is furthest from any high vibratory loading and/or in line with dampening and/or force transfer points for those vehicular mechanisms through which forces may be translated (e.g., wheels, propellors, skis, drive track). Thus, the fender mounted speaker system 50 may be placed at a position relative to the steering mechanism 5 that is no longer centrally located at the console 30 but may surround the user during the vehicle drive. Additionally, the speaker system 50 as located may free up useful space on the front 12 of the vehicle and avoid the need to attach speakers at locations that could be alternatively used for other items, e.g., equipment, spare parts.

According to another exemplary embodiment, an exemplary speaker system 50 may be angled with respect to the seated user in such a way that the sound emitted by the system substantially travels to the user with a minimal degree of interference by the portions of the steering mechanism 5 that may be located therebetween (such as, for example, the steering handlebars 5a and/or steering column 5b). As another exemplary improvement, an exemplary fender mounted speaker system 50 for a vehicle 100 may allow the emitted sound to traverse only those portions of the steering mechanism 5 that may be in the way at the time of its use as opposed to a consistent interference by the column 5b of the steering mechanism 5 or other parts of the front cowling 12 leading to the center console 30 as may have been the case in the prior art.

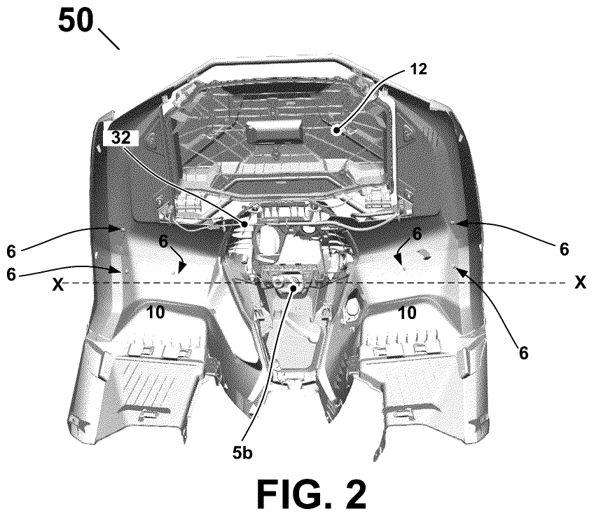

With reference to the exemplary embodiment of FIG. 2, an underside view of the fender mounted speaker system illustrated in FIG. 1 may be shown. Mounting bolts or screws 6 may be illustrated at pre-set portions of the fender 10 to enable mounting engagement with the speakers 20 above. While not shown, dampening washers, brackets, and other forms of vibration reduction may be used in conjunction with the mounting bolts 6 to ensure adequate adherence between the speakers 20 and the vehicle fender 10 and/or optimal vibrational control and reduction in sound interference. Another exemplary improvement provided by the fender mounted sound system 50 may be the case of electrical interconnectivity of the system with pre-existing vehicle electronics 32. For example, an exemplary fender mounted sound system 50 may comprise audio wiring that may be disposed within the same channels as that used for any electronic console 30 used on the vehicle, but such that the connections may take place underneath the vehicle fender. In other words, the sound system 50 may obtain its power and audio transmission connections at more accessible points than where a standard vehicle audio system may be located. Alternatively, as opposed to after-market set-ups in which the wiring for such systems must be hidden from view, the current fender mounted sound system 50 enables pre-defined locations for the sound systems to be installed and the wiring and harnesses associated with the same to be located and stored.

In yet another alternative embodiment, fender mounted sound system 50 may be configured to connect to the electronic components of the vehicle in console 30 via Bluetooth or other wireless connection mechanisms known to those skilled in the art. In this way, the system 50 may be engaged to the vehicle without the need for electronic wiring with the pre-existing components of the vehicle. In yet another alternative embodiment, the fender mounted sound system 50 may be a hybrid of wireless connectivity for receiving audio to project to the user but may be wired to allow for powering of the same by the battery of the vehicle or to be otherwise power-controlled using known mechanisms, such as key-on solenoids and the like.

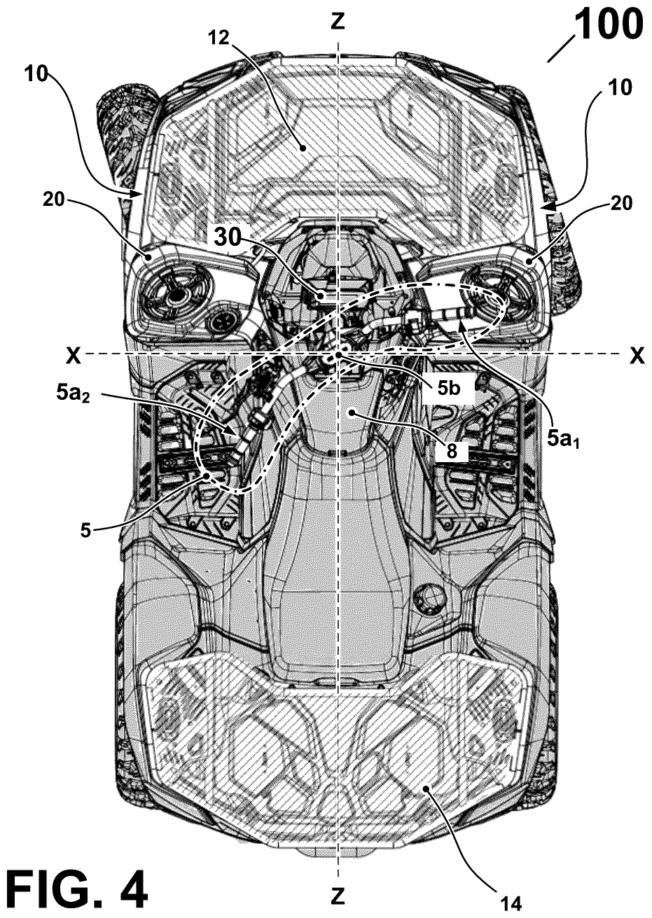

In an exemplary embodiment, the mounting points 6 for an exemplary fender mounted speaker 20 may be such as to align the speakers 20 laterally along transverse axis (demarcated X-X in FIG. 2) that is bisected by the steering column 5b of steering mechanism 5 of the vehicle 100 where steering column 5b connects to steering mechanism 5. As such, the exemplary fender mounted speaker 20 may be located at a point that is proximal to the user, but oriented in such a way on the fender 10 to avoid the travel of the steering mechanism 5 during vehicle 100 operation. An example of the degree of freedom capable of the steering mechanism 5 may be illustrated in FIG. 4, showing steering handles 5a1 capable of being turned into the same section as speaker 20 but without colliding with the same.

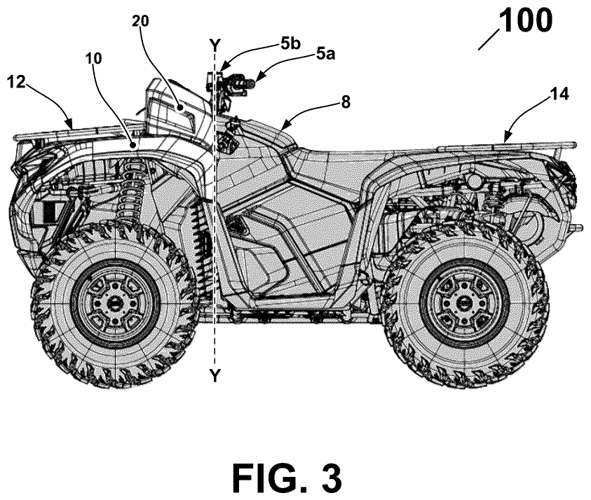

With reference to the exemplary embodiment of FIG. 3, an exemplary vehicle 100 may be shown from its side where the front cowling 12, fender 10, and sound system 50 may be depicted forward of axis Y-Y, which is the line perpendicular to the support surface of vehicle 100 when the vehicle 100 is at rest and in a neutral steering position on a flat horizonal surface. (e.g., vehicle 100 wheels facing straight ahead). Axis Y-Y passes through the point where the steering column 5b connects to the steering mechanism 5. In the rear of vehicle 100 may also be rear cowling 14. As shown in FIG. 3, either of front cowling 12 or rear cowling 14 may further comprise storage space or storage means for objects and other items that can be carried by vehicle 100. As shown in FIG. 3 and with additional reference to FIG. 4, an exemplary sound system 50 may be forward of the steering column 5b axis Y-Y, forward of the transverse axis X-X, and have its speakers 20 substantially equally spaced along a line parallel to axis X-X with respect to a longitudinal axis Z-Z down the center of the vehicle 100, such as, for example, the axis that is parallel with the supporting surface of vehicle 100 and equidistant between the wheel pairs (front or rear).

As a further enhancement provided by an exemplary fender mounted sound system 50, an exemplary vehicle fender 10 may be pre-designed to allow for mounting of various types of speaker systems 20 depending on needs. For this reason, the mounting to the fender may take the form of multiple different types of bolts 6. Alternatively, speakers 20 may be rigidly mounted to the fender 10 of an exemplary vehicle 100 using two or more interlocking devices, such as, for example, the commercially available Linq® system made and sold by Bombardier Recreational Products, Inc. of Valcourt, Quebec. In this way, a fender 10 of a vehicle 100 may be capable of accommodating a variety of speakers 20 provided the proper attachments exist at the mounting points 6 of the fender 10 and the speaker 20.

Many further variations and modifications may suggest themselves to those skilled in art upon making reference to above disclosure and foregoing interrelated and interchangeable illustrative embodiments, which are given by way of example only, and are not intended to limit the scope and spirit of the interrelated embodiments of the invention described herein.

1. A fender mounted speaker system for a vehicle having a longitudinal axis, a transverse axis, and a steering axis, wherein the longitudinal axis is an axis along a major length of the vehicle, wherein the transverse axis is perpendicular to the longitudinal axis and intersects a connection point between a steering column of the vehicle and a steering mechanism, the fender mounted speaker system comprising:
a plurality of speakers operatively connected to the vehicle for sound generation, each one of the plurality of speakers having a plurality of mounting points disposed on one surface of its casing and a sound emission point disposed on another surface of the casing; and
a fender mount on either side of the longitudinal axis of the vehicle, the fender mount comprising a plurality of mountings configured to align with at least one of the plurality of mounting points of each of the plurality of speakers,
wherein at least two of the plurality of speakers is mounted to a part of the vehicle so that the sound emission point of the at least two of the plurality of speakers is: (i) bisected by and equidistant from the longitudinal axis, (ii) forward of the transverse axis, (iii) forward of the steering axis, or (iv) combinations of (i)-(iii).

2. The fender mounted speaker system of claim 1, wherein the sound emission point of the at least two of the plurality of speakers is bisected by and equidistant from the longitudinal axis and forward of the transverse axis.

3. The fender mounted speaker system of claim 1, wherein each of the plurality of speakers is arranged to avoid sound interference from a steering mechanism for the vehicle, wherein the steering mechanism comprises the steering column.

4. The fender mounted speaker system of claim 1, wherein the fender belongs to an all-terrain vehicle having at least one wheel disposed below the fender.

5. The fender mounted speaker system of claim 8, further comprising a plurality of speakers mounted to the all-terrain vehicle by two different fenders.

6. The fender mounted speaker system of claim 9, wherein the fender mounted speaker system is electrically coupled to the all-terrain vehicle using pre-existing electrical connections for a console on the all-terrain vehicle.

7. The fender mounted speaker system of claim 10, wherein at least a portion of the electrical coupling for the fender mounted speaker system is disposed under the fender.

8. The fender mounted speaker system of claim 11, wherein the electrical coupling for the fender mounted speaker system is entirely disposed under the fender.

9. The fender mounted speaker system of claim 12, wherein each speaker of the speaker system is angled on the fender so as to avoid full rotation of the steering mechanism.

10. The fender mounted speaker system of claim 1, wherein each speaker of the speaker system is angled on the fender so as to avoid full rotation of the steering mechanism.

11. The fender mounted speaker system of claim 2, wherein each speaker of the speaker system is angled on the fender so as to avoid full rotation of a steering mechanism for the vehicle, wherein the steering mechanism comprises the steering column.

12. A fender mounted speaker system for a vehicle having a longitudinal axis, a transverse axis, and a steering axis, wherein the longitudinal axis is an axis along a major length of the vehicle, wherein the transverse axis is perpendicular to the longitudinal axis and intersects a steering column of the vehicle, wherein the steering axis is perpendicular to the longitudinal axis and the transverse axis and intersects a point of rotation of the steering column of the vehicle, the fender mounted speaker system comprising:
a plurality of speakers operatively connected to the vehicle for sound generation, each one of the plurality of speakers having a plurality of mounting points disposed on one surface of its casing and a sound emission point disposed on another surface of the casing; and
a fender mount on either side of the longitudinal axis of the vehicle, the fender mount comprising a plurality of mountings configured to align with at least one of the plurality of mounting points of each of the plurality of speakers,
wherein at least two of the plurality of speakers is mounted to a part of the vehicle so that the sound emission point of the at least two of the plurality of speakers is forward of the steering column and arranged to avoid full rotation of the steering mechanism.

13. A fender mounted speaker system for a vehicle having a longitudinal centerline, a set of handlebars connected to a steering column at a lateral midpoint of the handlebars along the longitudinal centerline and a storage rack at least partially in front of the handlebars, the fender mounted speaker system comprising:
at least one speaker connected to the vehicle for sound generation, the at least one speakers having a plurality of mounting points for mounting the at least one speaker to the fender; and
at least one sound emission point,
wherein that at least one speaker is mounted to the vehicle so that the sound emission point is at least partially forward of the lateral midpoint of the handlebars, at least partially rearward of the storage rack and arranged to avoid full rotation of the handlebars.

14. The fender mounted speaker system of claim 13, wherein the at least one speaker is two speakers separated from one another by the longitudinal centerline.

15. The fender mounted speaker system of claim 14, wherein each of the speakers is angled upward and toward the longitudinal centerline.

16. The fender mounted speaker system of claim 14, wherein each of the speakers is angled rearward and toward the longitudinal centerline.

17. The fender mounted speaker system of claim 14, wherein each of the speakers increase in vertical height further away from the longitudinal centerline.

18. The fender mounted speaker system of claim 14, wherein the speaker are forward of a seat on the vehicle, left and right footrests on the vehicle, or a combination of each of the same.
